(19) United States
(12) Patent Application Publication
(10) Pub. No.: US 2010/0122470 A1
(43) Pub. Date: May 20, 2010

(54) Dehumidifier for water damaged electronic devices

(76) Inventors: Bradley C. Davis, Baltimore, MD (US); Gregory Montgomery, Gastonia, NC (US)

Correspondence Address: ANDREW W. LUDY, 17 SHERWOOD WAY, P.O. Box 418, Mt. Arlington, NJ, 07856, US

(21) Appl. No.: 12/459,700

(22) Filed: Jul. 7, 2009

Related U.S. Application Data
(60) Provisional application No. 61/115,899, filed on Nov. 18, 2008.

(51) Int. Cl. F26B 3/02; H05B 3/02; F24J 1/00; F26B 21/08; F26B 19/00; F26B 25/06

(52) U.S. Cl. 34/472; 219/385; 126/263.01; 34/80; 34/61; 34/88; 34/202

(57) ABSTRACT

A dehumidifier is used for restoring a water damaged electronic device. The dehumidifier comprises a sealable watertight container having a wall with an inside surface. The container has an interior chamber, and an open end. The open end has a releasable seal. The wall has an anti-static property, which prevents electrostatic charges from damaging the electronic device.

The wall is a moisture barrier. The interior chamber is large enough to receive the electronic device. A desiccant material is placed within a water vapor-permeable enclosure, which is disposed within the interior chamber. The desiccant material is a hydrophilic material such as silica gel, calcium carbonate, molecular sieve, activated clay, or alumina. The container wall is generally transparent. A humidity indicator is placed within the interior chamber.

An optional heater is placed within the interior chamber.

### CROSS-REFERENCE TO RELATED APPLICATIONS

Reference is hereby made to provisional patent application, titled, “Air-tight, Moisture-Proof, Anti-Static Re-Sealable Container with Desiccant to De-Humidify Water Damaged Handheld Electronics to a Specified Humidity Level so as to Facilitate Recovery of Functional Operability;” filed by Bradley C. Davis, of Baltimore, Md., on Nov. 18, 2008, Ser. No. 61/115,899. The prior application is expressly incorporated herein by reference.

### STATEMENT REGARDING FEDERALLY SPONSORED RESEARCH OR DEVELOPMENT

Not Applicable

### BACKGROUND OF THE INVENTION

This invention relates to the field of dehumidifying containers, and more particularly to a dehumidifier for restoring handheld electronic devices that have been damaged by immersion in water, which may include other contaminants.

A handheld electronic device, such as a cellular phone, a digital music player, a digital messaging device, a handheld computer or calculator, digital camera, pager, GPS device, and the like, is carried and sometimes dropped by its user. Such a device, dropped into a puddle, lake, toilet, or ocean, will be damaged by the water, and rendered non-functional, especially if the water contains contaminants, such as salt water. Salt is an electrolyte, and will short out electrical circuitry.

In order to restore these expensive devices to functionality, the contaminants and the water must be removed. Firstly, the battery must be removed. Then the contaminants must be removed from the device by rinsing in de-ionized water, or with a cleaning fluid such as isopropyl alcohol. The water must then be removed thoroughly. During the entire process, the electronic device must be protected from electrostatic charges, which can build up on surfaces as humidity decreases. The high electrostatic voltages, discharged through a digital device, will destroy sensitive circuitry.

Containers for dehumidifying items are known and have taken a variety of configurations in the past. Some examples of dehumidifying containers in the prior art are found in the following patents:

Giraud, U.S. Pat. No. 7,213,720; Loop, U.S. Pat. No. 6,977,589; Boroson, U.S. Pat. No. 6,740,145; Neteler, U.S. Pat. No. 6,531,197; Cunanan, U.S. Pat. No. 5,907,908; Jersby, U.S. Pat. No. 6,273,942; and Brunner, U.S. Pat. No. 5,603,401; each disclose a sealable container, box, or bag having an integral desiccant pack or surface to control humidity within the container. The container is intended to hold items such as electronic components, instruments, medical specimens, etc.

Loop, U.S. Pat. No. 6,716,276; shows a desiccant bag with an integral moisture indicating, color change material.

None of the references discloses a process for cleaning and decontaminating the damaged article prior to dehumidifying. None of the prior art devices addresses the problem of electrostatic discharge destroying the electronic device. The above-described devices provide for shipping and storage in a low humidity atmosphere, but not for functional recovery or restoration of a damaged article.

Accordingly, there is a need to provide a dehumidifier for water damaged electronic devices that can provide for cleaning and decontaminating the damaged article.

There is a further need to provide a dehumidifier for water damaged electronic devices of the type described and that will preclude destruction of the electronic device by electrostatic discharge.

There is a yet further need to provide a dehumidifier for water damaged electronic devices of the type described and that has an integral moisture indicating, color change material.

There is a still further need to provide a dehumidifier for water damaged electronic devices of the type described and that will allow an unskilled person to restore a water damaged electronic device to full functionality.

There is another need to provide a dehumidifier for water damaged electronic devices of the type described and that can be manufactured cost-effectively in large quantities of high quality.

### BRIEF SUMMARY OF THE INVENTION

In accordance with the present invention, there is provided a dehumidifier 12, for use in restoring a water damaged electronic device 10. The dehumidifier 12 comprises a sealable watertight container 14 having a wall 16 with an inside surface 18. The container 14 has an interior chamber 20, and an open end 22. The open end 22 has a releasable seal 24. The wall 16 has an anti-static property, which prevents electrostatic charges from damaging the electronic device 10.

The wall 16 is a moisture barrier. The interior chamber 20 is large enough to receive the electronic device 10. A desiccant material 26 is placed within a water vapor-permeable enclosure 28, which is disposed within the interior chamber 20. The desiccant material 26 is a hydrophilic material such as silica gel, calcium carbonate, molecular sieve, activated clay, and alumina. The container wall 16 is generally transparent. A humidity indicator 30 is placed within the interior chamber 20.

An optional heater 34 is placed within the interior chamber 20.

### BRIEF DESCRIPTION OF THE SEVERAL VIEWS OF THE DRAWING

A more complete understanding of the present invention may be obtained from consideration of the following description in conjunction with the drawing, in which:

FIG. 1 is a top view of a dehumidifier for water damaged electronic devices, constructed in accordance with the invention.

FIG. 2 is a sectional, front elevational view of the dehumidifier for water damaged electronic devices of FIG. 1, taken along lines 2-2 of FIG. 1.

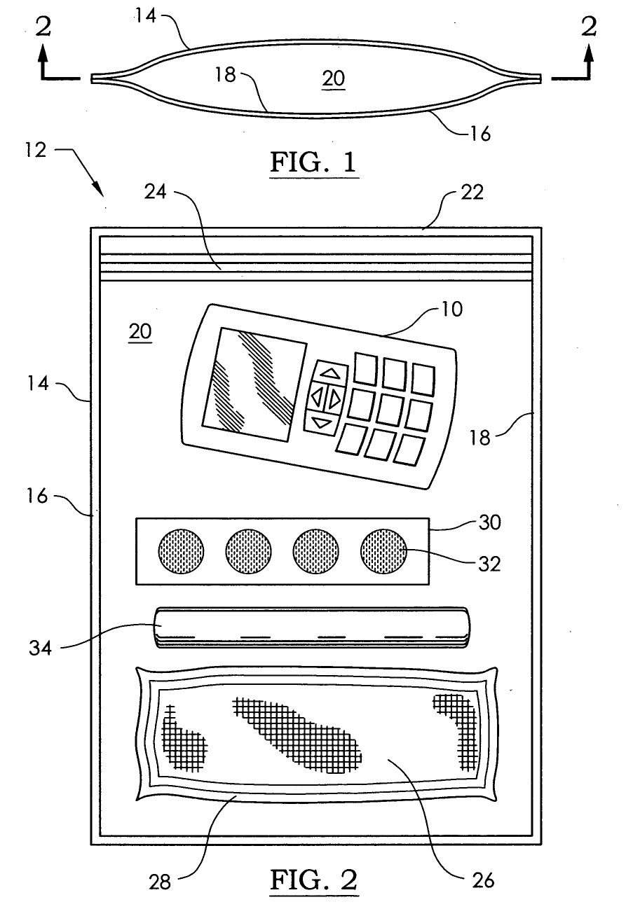

### DETAILED DESCRIPTION OF THE INVENTION

Referring now to the drawing, a dehumidifier is shown at 12, and is for use in restoring a water damaged electronic device 10 to full functionality. The dehumidifier 12 comprises a sealable watertight container 14 having a wall 16 with a wall inside surface 18. The container 14 has an interior chamber 20, and an open end 22. The open end 22 has a releasable seal 24. The wall 16 has an anti-static property, which prevents electrostatic charges from building up on surfaces as humidity decreases. The high electrostatic voltages, discharged through a digital device, will destroy sensitive circuitry. The anti-static property of the wall 16 thus protects the electronic device 10 from irreversible damage.

The wall 16, made from a polymeric material, is a moisture barrier. The interior chamber 20 is large enough to receive the electronic device 10. A desiccant material 26 is disposed within the interior chamber 20. In the preferred embodiment, a water vapor-permeable enclosure 28 is received within the interior chamber 20. The desiccant material 26 is disposed within the water vapor-permeable enclosure 28. An alternative is to coat the desiccant material 26 onto the wall inside surface 18. The desiccant material 26 is a hydrophilic material. Such materials commonly include: silica gel, calcium carbonate, molecular sieve, activated clay, and alumina, as well as other hydrophilic materials well known in the art.

The container wall 16 is generally transparent. A humidity indicator 30 is placed within the interior chamber 20. This can be a strip or card having spots 32 with a humidity indicating substance. Each spot 32 shows a different percent humidity as a change of color, typically from blue to pink. The percent humidity reading is visible through the transparent container wall 16. Humidity indicators of this type are well known in the art.

An optional heater 34 is placed within the interior chamber 20. The heater 34 can be an electrical heater 34 with an included battery (not shown). Preferably, an exothermic chemical heater 34 would be used. These chemical heat-generating devices are known, and usually employ two compartments separated by a membrane which, when ruptured, allow the chemicals to mix and react. The heater 34 provides gentle warmth to evaporate the water from the electronic device 10.

A dehumidifying method is also disclosed for restoring a water damaged electronic device 10 to functionality. The method comprises the steps of removing a battery (not shown) from the electronic device 10, and then removing contaminants by washing the electronic device 10. The washing is done with de-ionized water. Alternatively, alcohol or a water-soluble cleaner can be used. The preferred solvent is isopropyl alcohol. The next step is inserting the electronic device 10 into a sealable watertight container 14, and then sealing the watertight container 14 with a releasable seal 24. Next, providing a wall 16 of the container 14 with an anti-static property, and protecting the electronic device 10 from an electrostatic discharge with the anti-static property. Then, providing the wall 16 of the container 14 with a moisture barrier, and receiving a water vapor-permeable enclosure 28 within the container 14. Next, disposing a desiccant material 26 within the water vapor-permeable enclosure 28, and drying the electronic device 10 with the desiccant material 26. One with ordinary skill in the art has the option of selecting the desiccant material 26 from the group of hydrophilic materials consisting of: silica gel, calcium carbonate, molecular sieve, activated clay, and alumina.

Further steps comprise providing general transparency to the container wall 16, and placing a humidity indicator 30 within the container 14.

Yet further steps include placing a heater 34 within the container 14. The heater 34 can be either an electrical heater or, preferably, an exothermic chemical heater.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

### PARTS LIST

### Dehumidifier for Water Damaged Electronic Devices

### Part

| NO. | DESCRIPTION |
|---|---|
| 10 | electronic device |
| 12 | dehumidifier |
| 14 | watertight container |
| 16 | wall |
| 18 | wall inside surface |
| 20 | interior chamber |
| 22 | open end |
| 24 | releasable seal |
| 26 | desiccant material |
| 28 | water vapor-permeable enclosure |
| 30 | humidity indicator |
| 32 | spots |
| 34 | heater |

The embodiments of the invention in which an exclusive property or privilege is claimed are defined as follows:

1. A dehumidifier for a water damaged electronic device, comprising:
a sealable watertight container having a wall with a wall inside surface, an interior chamber, and an open end, the open end having a releasable seal, the wall having an anti-static property, the wall being a moisture barrier, the interior chamber being adapted to receive the electronic device; and
a desiccant material disposed within the interior chamber.

2. The dehumidifier of claim 1, further comprising:
a water vapor-permeable enclosure received within the interior chamber; and
the desiccant material being disposed within the water vapor-permeable enclosure.

3. The dehumidifier of claim 1, wherein the desiccant material is coated onto the wall inside surface.

4. The dehumidifier of claim 1, wherein the desiccant material is a hydrophilic material selected from the group consisting of: silica gel, calcium carbonate, molecular sieve, activated clay, and alumina.

5. The dehumidifier of claim 1, further comprising:
the container wall being generally transparent; and
a humidity indicator received within the interior chamber.

6. The dehumidifier of claim 1, further comprising an electrical heater disposed within the interior chamber.

7. The dehumidifier of claim 1, further comprising an exothermic chemical heater disposed within the interior chamber.

8. A method for dehumidifying a water damaged electronic device, the method comprising the steps of:
inserting the electronic device into a sealable watertight container;
sealing the watertight container with a releasable seal;
providing a wall of the container with an anti-static property;
protecting the electronic device from an electrostatic discharge with the anti-static property;
providing the wall of the container with a moisture barrier;
disposing a desiccant material within the container; and
drying the electronic device with the desiccant material.

9. The dehumidifying method of claim 8, further comprising the steps of:
receiving a water vapor-permeable enclosure within the container; and
disposing the desiccant material within the water vapor-permeable enclosure.

10. The dehumidifying method of claim 8, further comprising the step of coating the desiccant material onto an inside surface of the wall.

11. The dehumidifying method of claim 8, further comprising the step of selecting the desiccant material from the group of hydrophilic materials consisting of: silica gel, calcium carbonate, molecular sieve, activated clay, and alumina.

12. The dehumidifying method of claim 8, further comprising the steps of:
removing a battery from the electronic device prior to inserting the electronic device into the container; and
removing contaminants by washing the electronic device prior to inserting the electronic device into the container.

13. The dehumidifying method of claim 8, further comprising the steps of:
providing general transparency to the container wall; and
receiving a humidity indicator within the container.

14. The dehumidifying method of claim 8, further comprising the step of disposing an electrical heater within the container.

15. The dehumidifying method of claim 8, further comprising the step of disposing an exothermic chemical heater within the container.

16. A method for dehumidifying a water damaged electronic device, the method comprising the steps of:
removing a battery from the electronic device;
removing contaminants by washing the electronic device;
inserting the electronic device into a sealable watertight container;
sealing the watertight container with a releasable seal;
providing a wall of the container with an anti-static property;
protecting the electronic device from an electrostatic discharge with the anti-static property;
providing the wall of the container with a moisture barrier;
receiving a water vapor-permeable enclosure within the container;
disposing a desiccant material within the water vapor-permeable enclosure; and
drying the electronic device with the desiccant material.

17. The dehumidifying method of claim 16, further comprising the step of selecting the desiccant material from the group of hydrophilic materials consisting of: silica gel, calcium carbonate, molecular sieve, activated clay, and alumina.

18. The dehumidifying method of claim 16, further comprising the steps of:
providing general transparency to the container wall; and
receiving a humidity indicator within the container.

19. The dehumidifying method of claim 16, further comprising the step of disposing an electrical heater within the container.

20. The dehumidifying method of claim 16, further comprising the step of disposing an exothermic chemical heater within the container.
